(19) United States
(12) Patent Application Publication
(10) Pub. No.: US 2009/0119584 A1
(43) Pub. Date: May 7, 2009

(54) Software Tool for Creating Outlines and Mind Maps that Generates Subtopics Automatically

(76) Inventor: Steve Herbst, Carlisle, MA (US)

Correspondence Address: ROBERT PLOTKIN, PC, 45 BUTTERNUT CIRCLE, CONCORD, MA, 01742-1937, US

(21) Appl. No.: 12/259,500

(22) Filed: Oct. 28, 2008

Related U.S. Application Data
(60) Provisional application No. 61/001,559, filed on Nov. 2, 2007.

(51) Int. Cl. G06F 3/048; G06F 17/30; G06F 3/14

(52) U.S. Cl. 715/273; 707/6; 715/825; 707/E17.009

(57) ABSTRACT

A system automatically generates a text outline or mind map by applying pattern-matching translation rules to topic text. The system may be used as an educational aid for writing and/or brainstorming, or to enhance structured and in-depth thinking in any industry. A user may choose a topic, such as by choosing one of several topics displayed by the system or by typing a topic. In response, the system may apply rules to the topic to identify one or more relevant subtopics. The system may display the subtopics to the user. The user may select one of the subtopics, in response to which the system may apply the same or different rules to the subtopic to identify one or more additional subtopics. This process may be repeated to any depth to create and explore an outline, mind map, or other representation of topics related to the original topic.

### CROSS REFERENCE TO RELATED APPLICATIONS

This application claims priority from U.S. Provisional Patent Application Ser. No. 61/001,559, filed on Nov. 2, 2007, entitled “Software Tool for Creating Outlines and Mind-Maps that Generates Subtopics Automatically,” which is hereby incorporated by reference.

### BACKGROUND

1. Field of the Invention

Embodiments of the present invention relate generally to techniques for facilitating writing, critical thinking, and brainstorming of ideas. More specifically, embodiments of the present invention relate to an outline and mind-map generation tool with the capability to automatically generate subtopics.

2. Related Art

A variety of software tools exist for creating outlines and for graphically organizing ideas, documents, images, and other items. Rule-based expert systems that emulate the decision making activities of humans are also known. Brainstorming techniques that use general principles of combination and transformation to vary a person's own ideas are also known. Finally, methods of combining words from multiple lists to create innovative concepts are also known. However, these known tools, systems, techniques, and methods have shortcomings in enabling a user (e.g., a student) to explore a research topic.

### SUMMARY

A system automatically generates a text outline or mind map of arbitrary depth on any subject (e.g., research topic) by applying pattern-matching translation rules to topic text. The system may be used as an educational aid for writing and/or brainstorming. The same system, with appropriate translation rules, may be used to encourage creative and in-depth thinking in any industry. A user may choose a topic label, such as by choosing one of several topics displayed by the system or by entering a new topic label, for example, by typing or editing text. In response, the system may apply rules to the topic label to identify (e.g., generate) one or more relevant subtopic labels. The system may display the subtopic labels to the user. The user may select one of the subtopic labels, in response to which the system may apply the same or different rules to the subtopic label to identify one or more additional subtopic labels. This process may be repeated as often as desired by the user to create and explore an outline or mind map of the original topic.

An embodiment of the present invention is conceived of as a general-purpose tool; its field of use in any one application may be derived from the nature of the rules supplied to it. One advantage of this embodiment may be its ability to employ both (1) rules specific to a given subject matter or curriculum, and (2) general-purpose rules that may respond to a given sentence structure independent of the subject matter and may be applicable across a wide range of subjects.

In addition to educational uses, possible applications include the following non-limiting examples. In the field of marketing, an embodiment may be used to brainstorm innovative branding strategies or advertising campaigns. In the pharmaceutical industry, an embodiment may be used to brainstorm new drug combinations or variations. In the entertainment field, an embodiment may be used to brainstorm combinations of known dramatic elements to create innovative scripts. In manufacturing, an embodiment may be used to brainstorm variations on existing manufacturing methods. These are but a small non-limiting sample of possible uses, presented here to illustrate the wide applicability of embodiments of the present invention. In each case, the rules supplied to the embodiments may be tailored to the particular intended use. One of the advantages of an embodiment of the present invention is its ability to use text patterns within rules to generate specific, relevant suggestions from specific topics based solely on the presence of words, phrases, and sentence structure, irrespective of the subject matter being explored.

According to an embodiment of the present invention, a computer-implemented method may be provided. The computer-implemented method may include (A) identifying an input text string representing a topic, (B) determining whether the input text string matches a text pattern specified by a premise of a predetermined rule, and (C) if the input text string satisfies the text pattern, then identifying a plurality of output text strings specified by a conclusion of the predetermined rule.

According to another embodiment of the present invention, a computer-implemented method may be provided. The computer-implemented method may include (A) selecting, on a computerized display, an input text string representing a topic, (B) identifying a canonical text string by applying, to the input text string, a canonical transformation rule which maps a plurality of forms of sentences into a single canonical form, (C) for each rule R of a plurality of predetermined rules, (C1) identifying a text pattern specified by a premise of rule R, (C2) determining whether the identified canonical text string matches the text pattern specified by the premise of rule R, (D) if the identified canonical text string satisfies the text pattern specified by the premise of rule R, then identifying a plurality of output text strings specified by a conclusion of rule R, and (E) outputting the plurality of output text strings on the computerized display.

Other features and advantages of various aspects and embodiments of the present invention will become apparent from the following description and from the claims.

### BRIEF DESCRIPTION OF THE DRAWINGS

FIG. 1A is a flowchart of a computer-implemented method according to an embodiment of the present invention.

FIG. 1B is a flow chart of operations 105 and 107 which may be performed additionally or alternatively to operations 104 and 106 of FIG. 1A.

FIGS. 1C and 1D are flowcharts of computer-implemented methods according to alternate embodiments of the present invention.

FIG. 2 is a dataflow diagram of a system to perform the method of FIG. 1A according to an embodiment of the present invention.

FIGS. 3A-3D are schematic representations of screen shots of the system of FIG. 2 according to an embodiment of the present invention.

FIG. 4 is a schematic representation of a screen shot of the system of FIG. 2 according to an embodiment of the present invention.

FIG. 5 is a schematic representation of a functional overview of the system 200 of FIG. 2 according to an embodiment of the present invention.

FIG. 6 is a schematic representation of a system architecture (hardware and software) of the system of FIG. 2 according to an embodiment of the present invention, including an HTML outline within a standard web browser.

FIG. 7A is a schematic representation of five-stage rule processing that each request from the web page may undergo.

FIGS. 7B-7F are schematic representations of the five stages of FIG. 7A according to an embodiment of the present invention.

FIG. 8 is a schematic representation of special symbols that may be used to build rules according to an embodiment of the present invention.

FIG. 9 is a schematic representation illustrating how stage 1 of request processing, in which topic text may be translated into a standardized wording, may make it possible for a single general rule to produce specific subtopics on a wide range of subjects.

FIG. 10 is a flowchart of a computer-implemented method according to an embodiment of the present invention.

FIG. 11 is a dataflow diagram of a system to perform the method of FIG. 10 according to an embodiment of the present invention.

### DETAILED DESCRIPTION

Educators and parents of school age children may worry that the easy availability of Internet search via Google, Wikipedia, and other web sites may replace users' (e.g., students') critical thinking skills with search skills. Given a writing assignment, users may find it easier to search the web and copy text from existing articles than to think deeply about a subject and draw their own conclusions. It may be easier to react than to create, to synthesize rather than analyze. According to an embodiment of the present invention, blind search and copying may be replaced by an equally compelling interactive experience: that of answering automatically-generated questions which probe the user to think about the assigned topic in depth. An embodiment of the present invention may provide a convenient solution to writer's block by offering the user exploratory possibilities at any point in the user's thinking. The generated topics may, depending on the rules involved, favor questions and short topic headings rather than complete statements, thereby encouraging the user to think more deeply rather than copy text to produce a finished essay.

An embodiment of the present invention may be embodied within a software program that may provide a simple editor for outlines or mind maps. As used herein, the term “mind map” means “a graphic organizer representing terms, topics, relationships, hierarchy, and other concepts related to a particular term, topic, or other item.” In addition to the conventional capabilities of inserting, editing, moving, and deleting items, the program may contain an automatic feature for automatically generating text describing topics that are related to any topic in the outline. The automatic generation feature, applied to the text of any topic in the outline, may invoke a rule-based expert system to generate probing questions and text describing potential related topics (e.g., subtopics). Users may edit and expand the generated text that interests them and delete the rest.

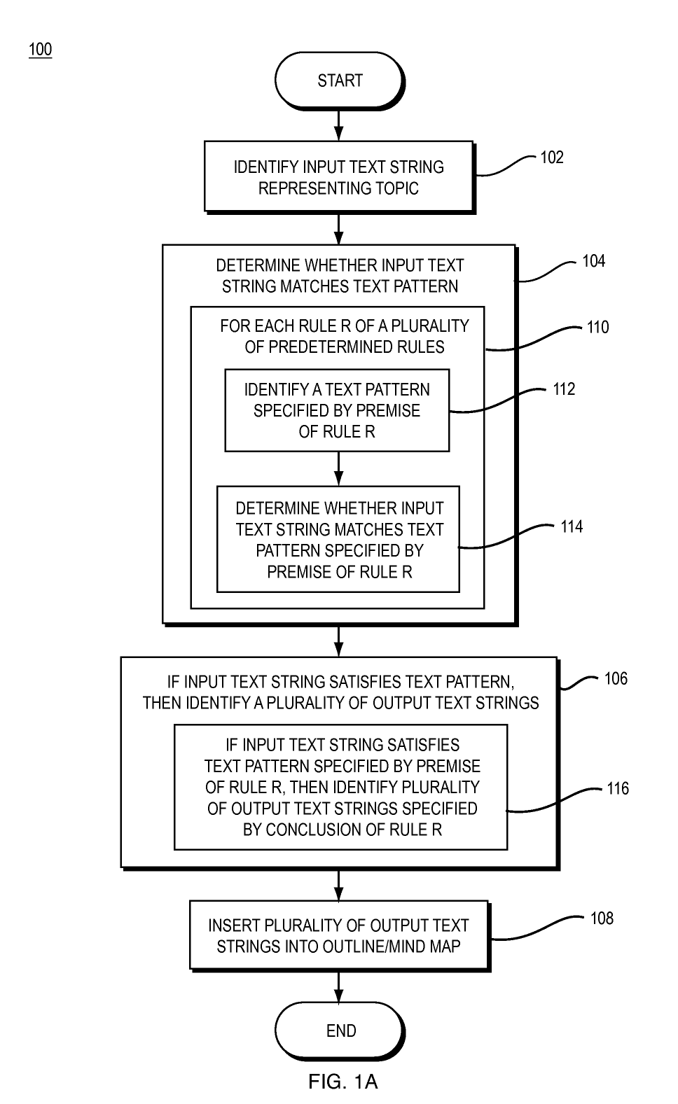

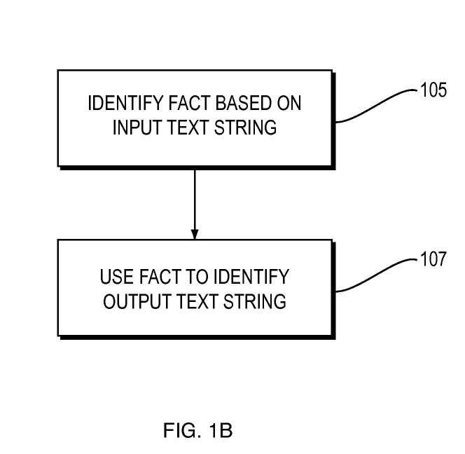

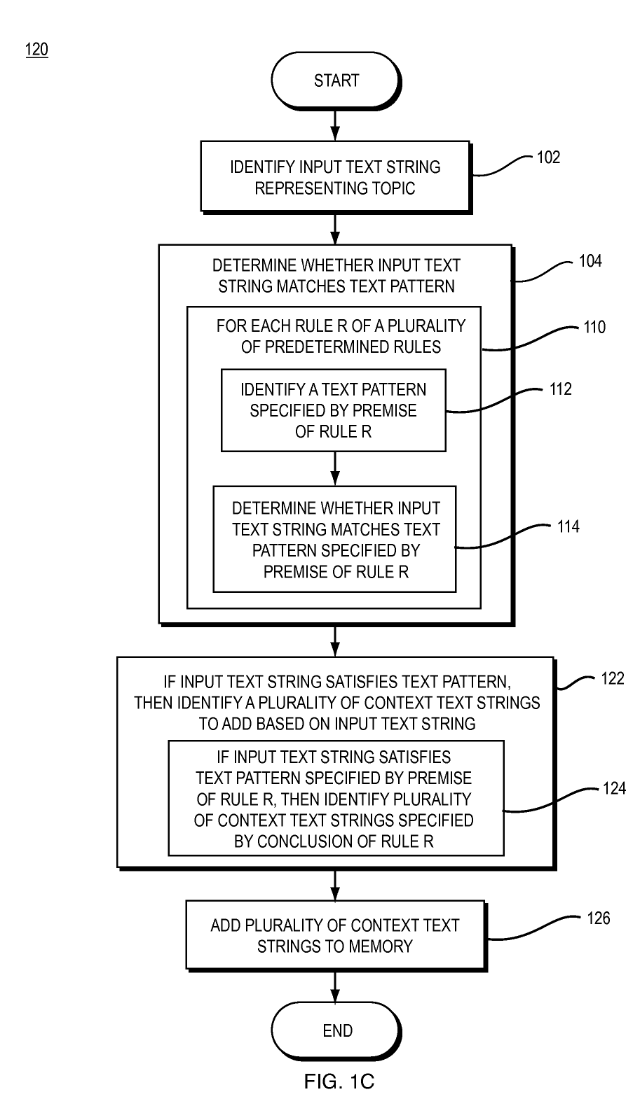

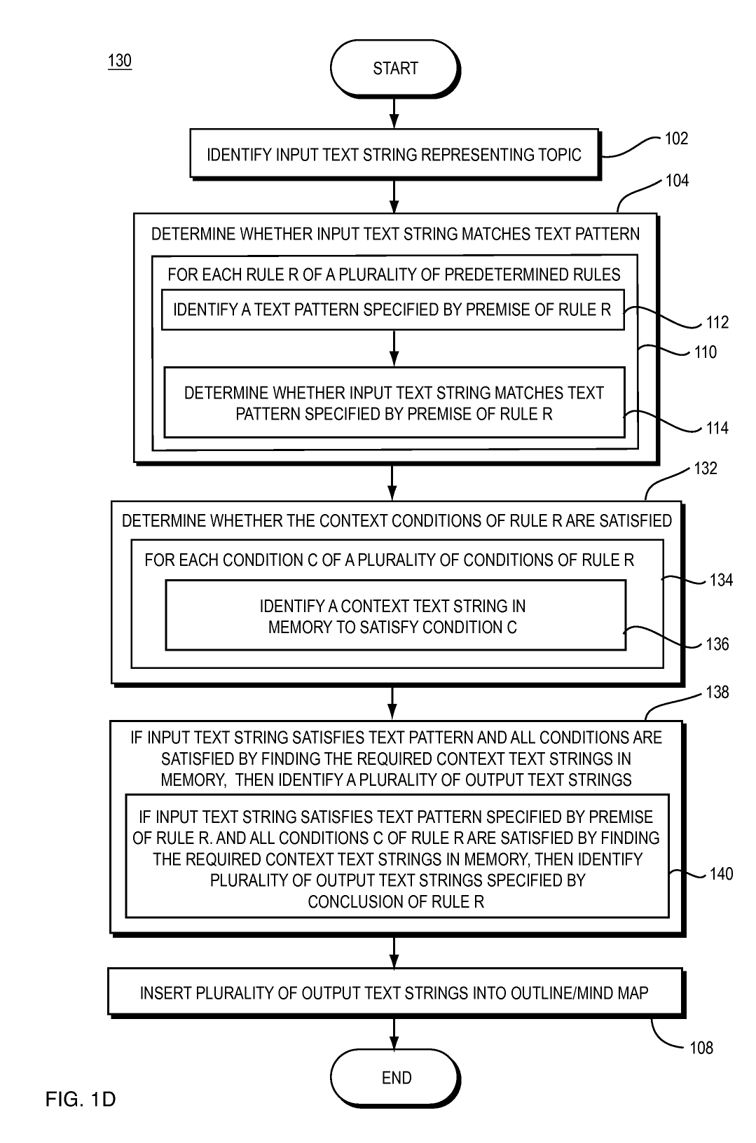

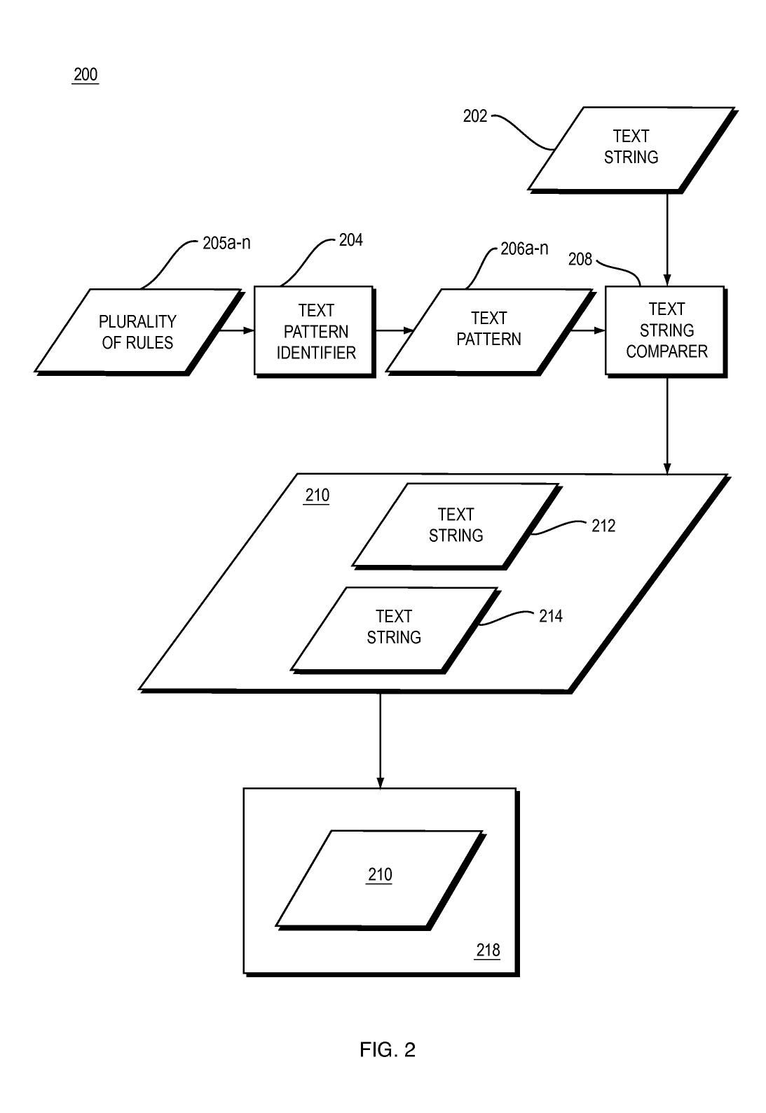

FIG. 1A is a flowchart of a computer-implemented method 100 according to an embodiment of the present invention. FIG. 2 is a dataflow diagram of a system 200 to perform the method 100 of FIG. 1A according to an embodiment of the present invention.

In the following description, when an operation is said to involve the application of a rule, that operation may be accomplished by applying a plurality of rules, in sequence or in parallel or by some other means of combining the effects of several rules to produce one or more conclusions from a premise.

In operation 102, a text string 202 may be identified within a presentation. By way of non-limiting example, a user may choose a topic in an outline or mind map and click a button. The topic may be associated with descriptive text, referred to herein as a “topic label.” Such a topic label may serve as the text string 202. For example, consider a student who is given the assignment to “Compare Plato's idea of justice with that of Socrates.” The “topic” in this case is a comparison of Plato's idea of justice with that of Socrates. The “topic label” in this case is the text “Compare Plato's idea of justice with that of Socrates.” (Note that more than one topic label may be associated with any particular topic, as in the English language, there is more than one way to express a given concept.)

The user may or may not select the topic label by directly selecting (e.g., typing or clicking on) the text string 202 itself. For example, although the user may select the input text string 202 by selecting (e.g., clicking on) a visual representation of the text string 202, as another example the user may select an icon which represents the topic (comparison of Plato's idea of justice with that of Socrates), in response to which the system 200 identifies the corresponding text string 202 (topic label). As a further example, the user may copy text from a web page and paste it into an edit box, in response to which the system 200 identifies the resulting contents of the edit box as the corresponding text string 202.

A canonical text string may be identified by applying, to the input text string 202, a canonical transformation rule. The canonical transformation rule may map a plurality of forms of sentences into a single canonical form. In this way, the set of topic labels (text sentences) representing a topic (concept) may be transformed into a single agreed upon canonical topic label representing that concept, so that the canonical topic label may serve in place of the original topic label as the input text string 202. As a result of this transformation to canonical form, fewer rules may be needed by embodiments of the invention.

By way of non-limiting example, the canonical transformation rule may be IF TOPIC MATCHES ANY OF THESE PATTERNS: “compare A's X with that of B,” “compare A's X to that of B,” “compare A's X with B's X,” “compare A's X with B's,” “compare A's X to B's,” “compare the X of A and B,” “compare A's to B's X;” THEN TRANSLATE IT INTO: “compare A's X to B's X”. In this example, “compare A's X to B's X” is the canonical form into which the rule translates all other forms. For example, the topic label “Compare Plato's idea of justice with that of Socrates” would be translated into the canonical form “Compare Plato's idea of justice to Socrates' idea of justice” by this canonical transformation rule. In the following discussion, assume for purposes of example that the text string 202 has been transformed into a canonical form before the initiation of operation 104.

In operation 104, a determination may be made by a text string comparer 208 whether the input text string 202 matches a text pattern 206a output by a text pattern identifier 204. By way of non-limiting example, the text pattern 206a may be “compare P to Q,” in which case the determination performed by text string comparer 208 may be DOES TOPIC MATCH: “compare P to Q.” In the present example, the canonical text string “Compare Plato's idea of justice to Socrates' idea of justice” would match the text pattern “compare P to Q” with P matching “Plato's idea of justice” and Q matching “Socrates' idea of justice”.

The text string comparer 208 may repeat this determination for multiple text strings if, for example, the text pattern identifier 204 enters a loop 110 over a plurality of predetermined rules R 205a-n, and outputs corresponding text patterns 206a-n corresponding to premises of the rules R 205a-n in operation 112. In operation 114, the text string comparer 208 determines, for each of the text patterns 206a-n, whether the input text string 202 matches the text pattern. The result of performing loop 110 is that the system determines which of the plurality of rules 205a-n apply to the input text string 202.

If it is determined that the input text string 202 satisfies the text pattern 206a, a plurality of output text strings 210 may be identified in operation 106. That is, the system 200 may respond to the standardized wording of the canonical form of the text string by suggesting a plurality of subtopics, thereby helping the user to follow and learn a structured method of analyzing an idea. Turning back to the non-limiting example above (DOES TOPIC MATCH: “compare P to Q”), operation 106 may include outputting the following subtopics: “describe P,” “describe Q,” “how is P similar to Q?”, and “how is P different from Q?”. In this way, four subtopics may be output helping the user to follow and learn a structured way of comparing two ideas.

The identification of the plurality of output text strings 210 may include operation 116. If it is determined that the input text string 202 satisfies the text pattern 206a specified by the premise of rule R, a plurality of output text strings 210 specified by a conclusion of rule R may be identified in operation 116. For example, it may be determined that the input text string 202, “compare Plato's idea of justice to Socrates' idea of justice” matches the text pattern 206a specified by the premise of rule R. Thus, the following plurality of output text strings 210 specified by the conclusion of rule R may be identified: “describe Plato's idea of justice,” “describe Socrates' idea of justice,” “how is Plato's idea of justice similar to Socrates' idea of justice?”, and “how is Plato's idea of justice different from Socrates' idea of justice?” These new subtopics suggest to the user a structured way to approach comparing these two specific ideas.

In operation 108, the identified plurality of output text strings 210 may be inserted into the user's outline or mind map 218.

FIG. 1B is a flowchart of operations 105 and 107 which may be performed additionally or alternatively to operations 104 and 106 of FIG. 1A. In operation 105, a context text string (sometimes referred to as a “fact”) may be identified based on the input text string 202. In operation 107, that context text string may be used to identify an output string.

FIG. 1C is a flowchart of a computer-implemented method 120 according to an alternative embodiment of the present invention. Operations 122 and 126 may be an exemplary implementation of operation 107 in FIG. 1B. In operation 122, if it is determined that the input text string 202 satisfies the text pattern, a plurality of context text strings may be identified for addition. FIG. 1C may differ from FIG. 1A in that the identification of a plurality of output text strings in 106 and 116 and the insertion of the text strings into an outline or mind map in 108 may be replaced by the identification of a plurality of context text strings in 122 and 124 based on the input text string and matching rule, and the storing of these context text strings into memory in 126 so that they can be found by later searches. According to this embodiment, the system 120 may build a context for the user session consisting of a set of facts in memory that may be referenced by rules.

FIG. 1D is a flowchart of a computer-implemented method 130 according to an alternative embodiment of the present invention. Operations 132 and 138 may be an exemplary implementation of operation 107 in FIG. 1B. In operation 132, a determination may be made whether context conditions of rule R are satisfied. In operation 138, if it is determined that the input text string 202 satisfies the text pattern and all context conditions are satisfied by finding the required context text strings in memory, a plurality of output text strings 210 may be identified. FIG. 1D may differ from FIG. 1C in that rather than store context text strings in memory as shown in operations 122, 124, and 126, rules may contain conditions that search (operations 132, 134, and 136) for the existence of context text strings that may have been stored previously. Such context text strings may have been stored by previously applied rules according to the embodiment in FIG. 1C. If the context text strings needed to satisfy a rule's conditions have been found in memory as described in operations 138 and 140, a plurality of output text strings 210 may be inserted into the outline or mind map using the same operation 108 as shown in FIG. 1A.

A few additional examples may clarify how pattern-matching rules may operate within the system 200.

### EXAMPLE 1

### Single Word: “Causes”

A user's outline may contain the topic: “Warm air rising causes hurricanes”. A person examining this simple statement may think of many related questions about cause and effect whose answers may make the user's essay more interesting. Some of this thinking may be simulated by translation rules. For any topic of the form: “$$x causes $$y” where $$x and $$y are wild-cards that match any word or phrase, rules can generate meaningful questions for further exploration, as indicated by the examples of “Conclusions” in Table 1.

TABLE 1

| RULE: | APPLICATION OF RULE: |
|---|---|
| Premise (text pattern): | Premise (text string, or topic |
| | label): |
| $$x causes $$y | Warm air rising causes |
| | hurricanes |
| Conclusions (output text | Conclusions (output text |
| strings): | strings, or subtopics): |
| define $$x | Define warm air rising. |
| define $$y | Define hurricanes. |
| find evidence that $$x causes | Find evidence that warm air |
| $$y | rising causes hurricanes. |
| how does $$x cause $$y? | How does warm air rising cause |
| | hurricanes? |
| what else besides $$x causes | What else besides warm air |
| $$y? | rising causes hurricanes? |
| what else besides $$y does $$x | What else besides hurricanes |
| cause? | does warm air rising cause? |
| what can prevent $$x from | What can prevent warm air |
| causing $$y? | rising from causing |
| | hurricanes? |
| what causes $$x? | What causes warm air rising? |
| how much $$x is needed to | How much warm air rising is |
| cause $$y? | needed to cause hurricanes? |
| can $$x also be used to detect | Can warm air rising also be |
| $$y? | used to detect hurricanes? |
| who is an expert on $$x? | Who is an expert on warm air |
| | rising? |
| who is an expert on $$y? | Who is an expert on |
| | hurricanes? |

The user may choose which of these generated questions and instructions to build upon, and delete the others. Thus a simple pattern that may require only the single word “causes” can produce meaningful, specific English questions about a cause and effect topic that encourage the user to explore the topic in greater depth.

### EXAMPLE 2

### Multiple Words

A writing topic may be: “Compare the government of ancient Athens to the government of Sparta.” As the system 200 applies transformation rules to this text string, fact generator 226 may apply a rule that responds to the word “ancient” by storing the context text string (or fact) “history” via step 126 in FIG. 1B and may apply another rule that responds to the word “government” by storing the context text string “government” and may apply another rule that responds to the word “Athens” by storing the context string “place”. These context text strings create a context, or set of assumptions, local to the topic to guide further subtopic generation. The user at this point may enter the text string “Elections” as a subtopic of the “Compare” topic. Additional rules may respond to this subtopic by finding the context text strings that were stored above via step 136 in FIG. 1C, with the results listed below in Table 2.

TABLE 2

| SUBTOPIC ENTERED BY USER: | |
|---|---|
| Elections | |
| AUTOMATICALLY-GENERATED | DERIVED FROM “elections” |
| TEXT (SUBTOPICS): | AND CONTEXT TEXT STRING: |
| Compare elections to today | history |
| Compare elections to where you | place |
| live | |
| Elections and daily life | history and place |
| Economic influences on elections | government |
| Social influences on elections | government |

### EXAMPLE 3

### Imposing Structure: Narrative

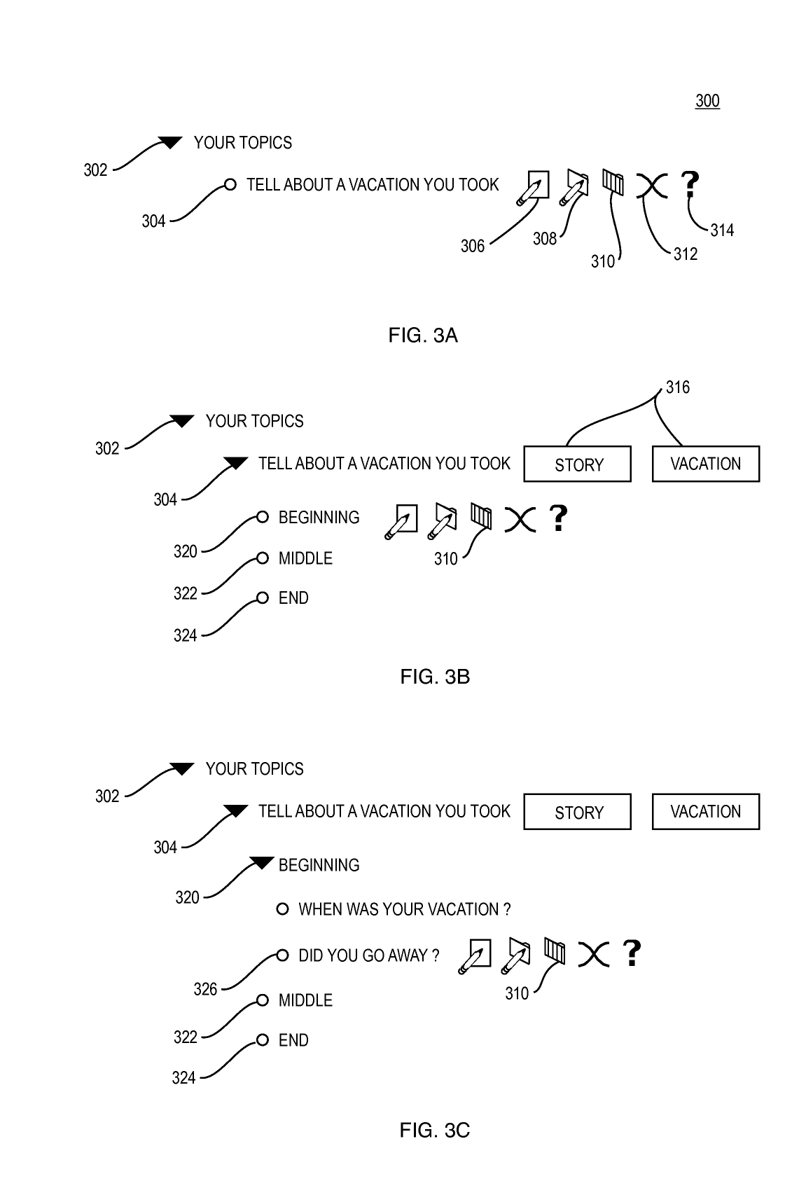

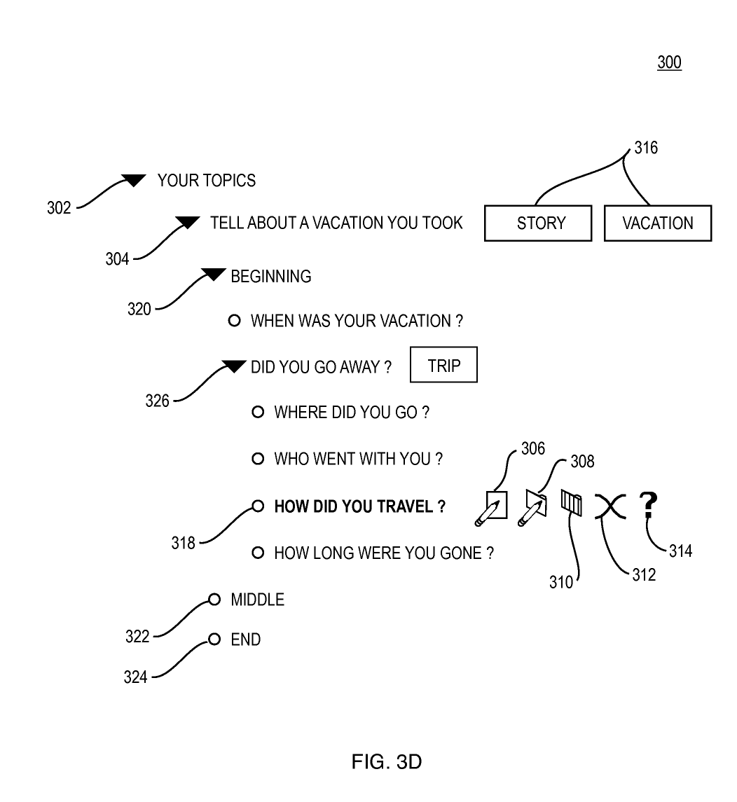

A writing topic may be: “Tell about a vacation you took.” A rule containing the pattern: “tell about $$x” may infer (by storing the context “story”) that this topic requires an answer in the form of a story. Meanwhile, another rule containing the pattern: “$$x vacation $$y” may infer (by storing the context “vacation”) that the topic concerns a vacation. The first rule may generate three subtopics typical of a narrative form: “beginning,” “middle,” and “end.” When the student expands the subtopic “beginning”, a rule specific to both stories and vacations, because its conditions require the existence of both context text strings “story” and “vacation”, may suggest possible subtopics: IF TOPIC IS: “beginning” AND IF: “story” AND IF: “vacation” THEN INSERT THESE SUBTOPICS: “When was your vacation?” “Did you go away?”. The effect of this rule is illustrated in a sample embodiment shown in FIGS. 3A-3D discussed below.

### EXAMPLE 4

### Improving Grammar: “Very unique”

In addition to generating subtopics and questions, the system may use rules to detect wording that the rule designers may wish the user to change. For example, the user may enter a topic containing the phrase “very unique”. A rule may respond to this phrase by recommending a change to the wording of the topic text, since the term “unique” is absolute and does not benefit from a modifier such as “very”. Such a rule might say: IF TOPIC CONTAINS: “very unique” THEN INSERT THIS SUBTOPIC: “If the subject is truly one-of-a-kind, consider removing the word VERY before UNIQUE in the topic above”.

FIGS. 3A-3D are schematic representations of screen shots of the system 200 of FIG. 2 according to an embodiment of the present invention. The screen shots are of a text outline 300. Each entry in the outline 300 may be referred to as a topic label. In this screen shot, the top-level topic, having a topic label 302 of “Your topics”, may have a subtopic with a topic label 304 of “Tell about a vacation you took”. The downward pointing green triangle on the top level topic label 302 may indicate that the top level topic has one or more subtopics and that their labels may be currently visible (expanded).

In this screen shot, the user may have selected (e.g., clicked) a subtopic, causing the topic label 304 text to turn bold and five buttons to appear. Button 306 may allow the user to edit the selected topic label. Button 308 may create a subtopic containing text that the user may type into an edit box. Button 312 may delete the selected subtopic 304. Button 314 may provide help. Button 310, the automatic generation feature, may apply pattern-matching text translation rules to the text of the topic label 304, which may sometimes store context text strings and/or generate subtopics, such as by applying to the topic label 304 the techniques disclosed above with respect to FIGS. 1 and 2.

FIG. 3B is a schematic representation of a later screen shot of the outline 300 of FIG. 3A with an additional level of subtopics. This progression may be the same as described in Example 3 (Imposing Structure: Narrative) above. Clicking the button 310 next to topic label 304 when that subtopic was selected may store the context text strings “story” and “vacation”, echoed as captions 316 so that the user may see what assumptions the system may be making. Responding to the “story” fact, rules may generate the subtopics “Beginning” 320, “Middle” 322, and “End” 324. In FIGS. 3C and 3D, the user may then click the 310 buttons of “Beginning” 320 and “Did you go away?” 326 to produce the depicted subtopics, including “How did you travel?” 318.

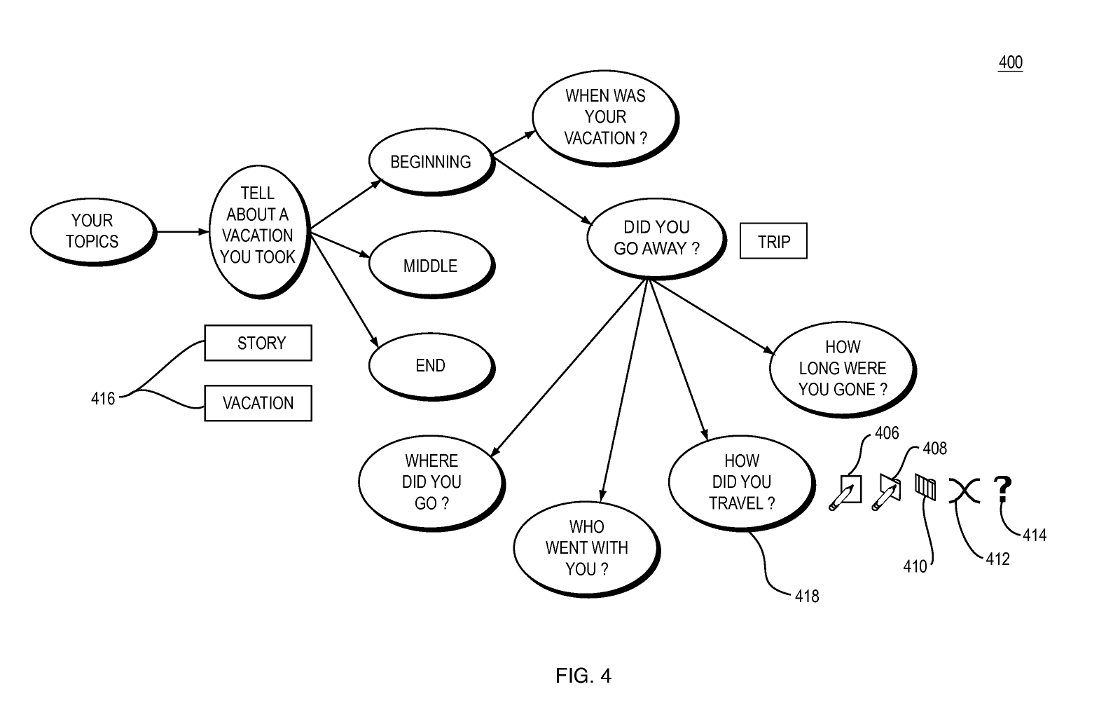

FIG. 4 is a schematic representation of a screen shot of the system 200 of FIG. 2 according to an embodiment of the present invention. The screen shot is of a mind map 400, with subtopic 418 “How did you travel?” selected.

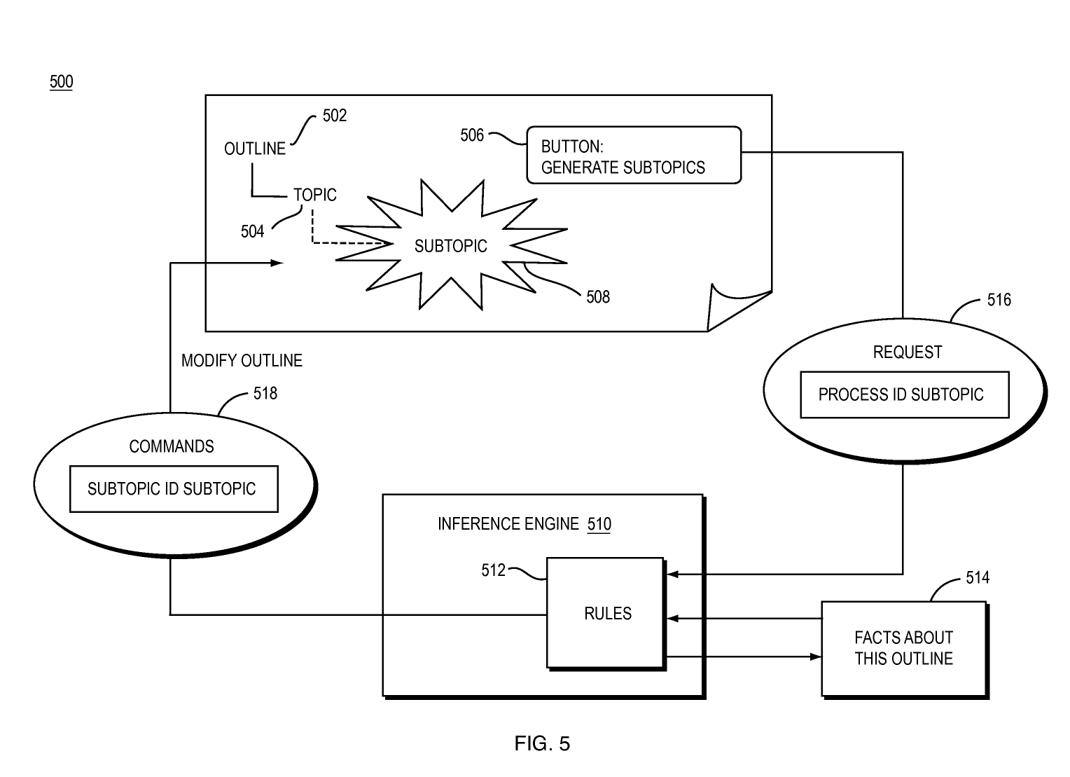

FIG. 5 is a schematic representation of a functional overview 500 of the system 200 of FIG. 2 according to an embodiment of the present invention. This schematic representation shows the relationship between the inference engine's application of rules depicted in FIGS. 1 and 2 and the screen presentation. An outline (or mind-map) 502 may be a document, which may be displayed on a computer screen. In one embodiment, the outline 502 may be an HTML document, which may be displayed in a web browser. The outline 502 includes one or more topics. Any topic 504 at any position in the outline 502 (or mind map) may have one or more subtopics 508.

The system 200 may operate as follows: clicking a Generate button 506 next to an outline topic 504 may send a request 516 to an inference engine 510. The request 516 may constitute the identified text string 202, which may be a label of the selected topic 504. The inference engine 510 may constitute the text pattern identifier 204 and the text string comparer 208. The inference engine 510 may apply rules 512 to the request 516 to generate one or more commands 518, which may be sent back to the browser to modify the outline 502. The one or more commands 518 may constitute the plurality of output text strings 210.

Request 516 may be of the form “process ID TOPIC,” where ID may uniquely identify the topic 504 whose button was clicked and TOPIC may be the topic label. The inference engine 510 may receive this request and apply translation rules 512 to the TOPIC label. The rules may produce commands 518 of various types. The command “subtopic ID SUBTOPIC” may insert the text SUBTOPIC into the outline 502 as a child of the topic 504 identified by ID. In addition to modifying the outline 502 (or mind map), rules may store context text strings 514 about the topic 504 being expanded. Rules may use these context text strings to guide the generation of additional subtopics.

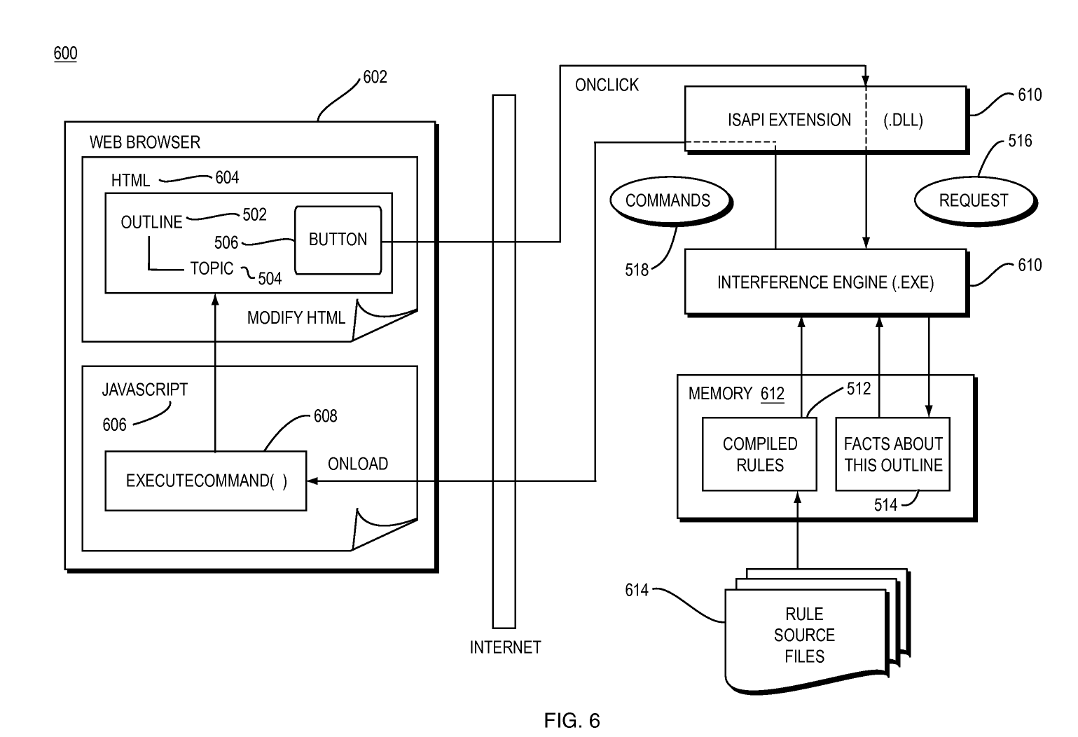

FIG. 6 is a schematic representation of a system architecture (hardware and software) 600 of the system 200 of FIG. 2 according to an embodiment of the present invention, including an HTML outline 604 within a standard web browser 602. The buttons that may appear next to each topic 504 when the user selects that topic 504 may be HTML tags with onClick handlers. Clicking a “Generate subtopics” button 506 may send an HTTP request to an ISAPI extension DLL 610, which may forward the request to the inference engine 510. The inference engine 510 may run continuously, processing requests from the ISAPI extension DLL 610 and returning commands. Requests and commands may be character strings.

The inference engine 510 may have previously compiled its rules from a set of ASCII source files 614 on disk into memory 612 in a format 512 that may allow fast searching. Alternatively to source files 614, the source of the rules may be a relational database or other repository. When a request 516 comes in, the inference engine 510 may quickly find and apply all matching rules 512 in memory 612 to the topic label within the request.

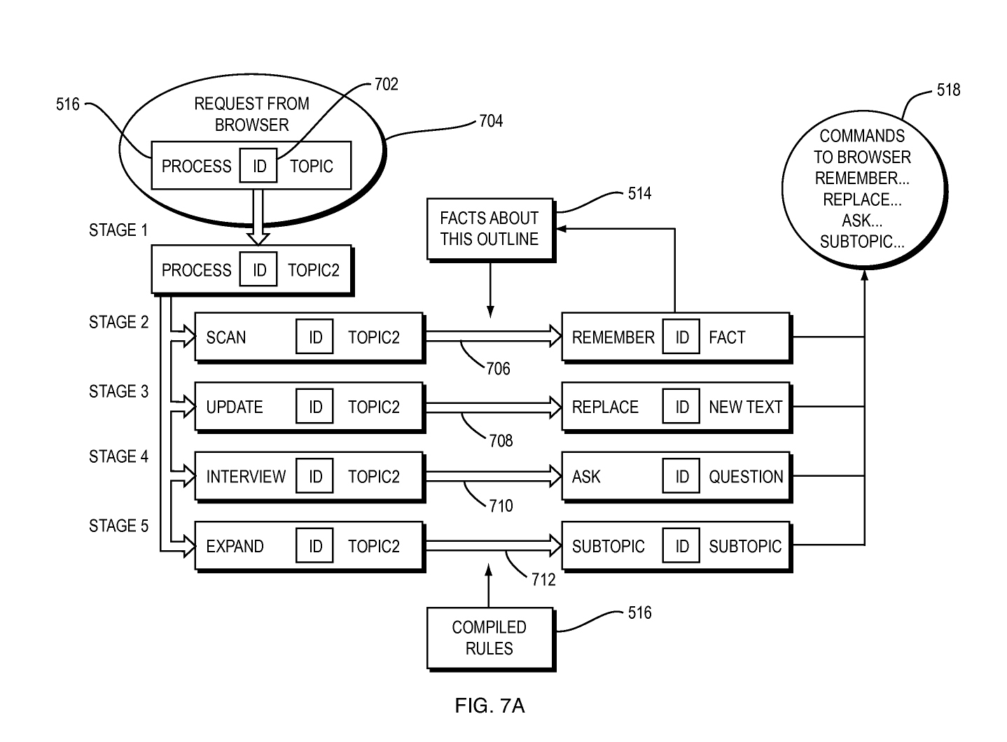

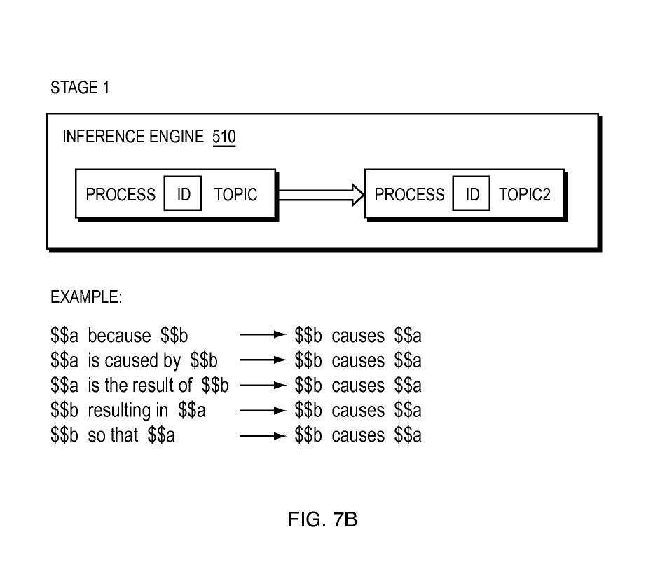

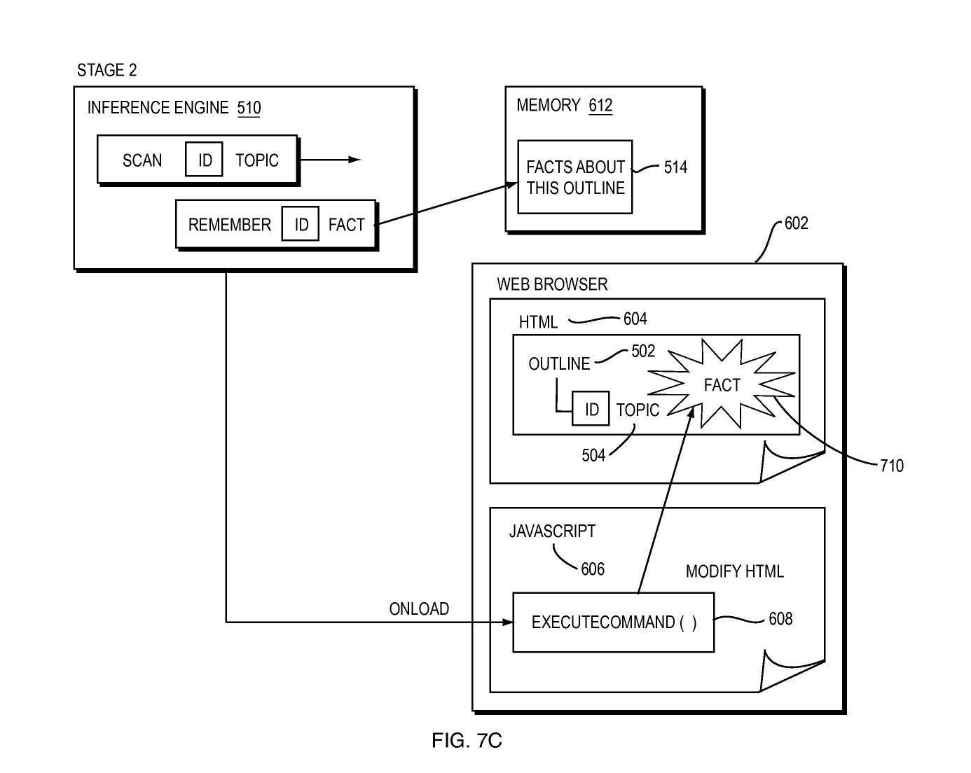

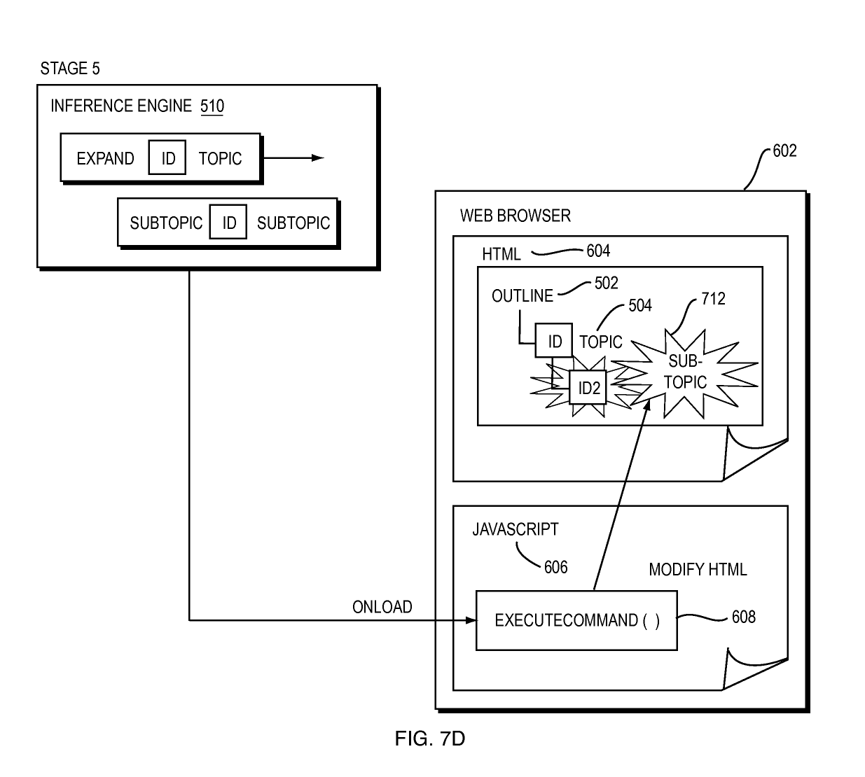

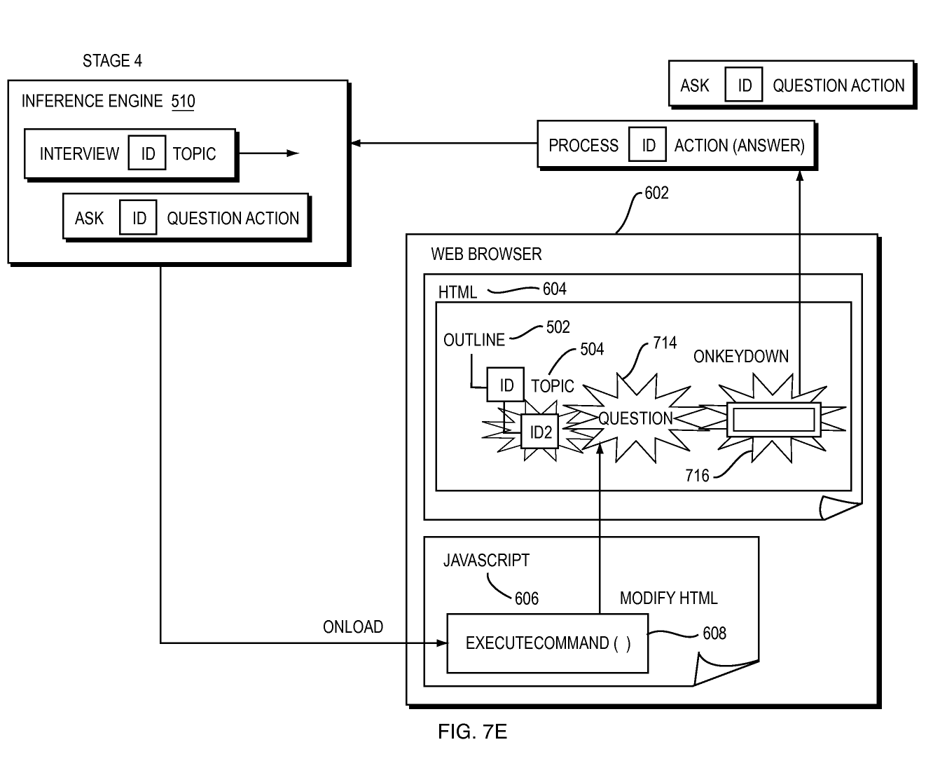

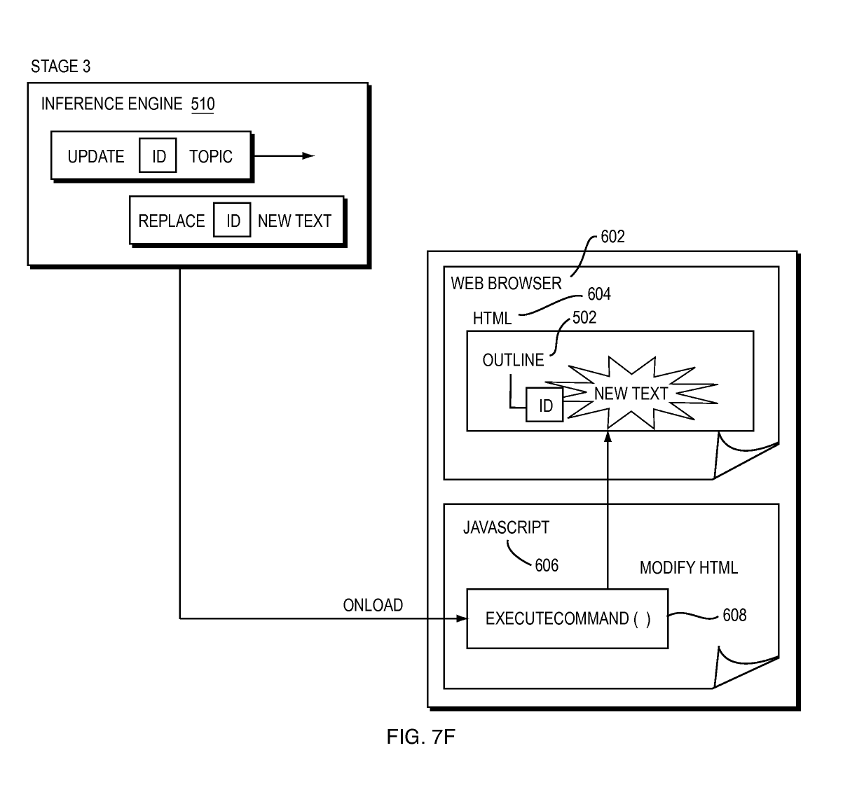

The results of applying rules may include (1) storing new facts 514 in the inference engine's 510 memory 612; (2) adding commands to the list of commands 518 that may be sent back via the ISAPI extension DLL 610 to the web browser 602 in the form of an onLoad handler that may pass the list of commands to the JavaScript function ExecuteCommand 608. This function may unpack the list and perform a specific action for each command. Commands may modify the outline (or mind map) as illustrated in FIGS. 7A-F below.

FIG. 7A is a schematic representation of five-stage rule processing that each request 516 from the web page may undergo. Each request 516 may be a string of the form “process ID TOPIC”, where ID 702 may uniquely identify the topic that issued the request and TOPIC may be that topic's text.

Embodiments of system architecture 600 may allow multiple users on multiple browsers to create distinct screen presentations (outlines or mind maps) by calling a single ISAPI DLL 610 communicating with a single inference engine 510. For a multi-user embodiment, the topic identifier ID 702 may be extended to include identification of the browser session, the user, and the presentation in addition to the topic within the presentation.

In stage 1, the inference engine 510 may apply rewrite rules 704 that may reduce the topic label from a range of possible language (e.g., English) expressions into a smaller number of standardized language wordings for the other rules to work on.

For stages 2 through 5, rules may translate “process ID TOPIC” into four other requests: “scan ID TOPIC”, “update ID TOPIC”, “interview ID TOPIC”, and “expand ID TOPIC”. In stage 2, “scan” rules 706 may produce “remember” commands that may store context text strings in memory. In stage 3, “update” rules 708 may produce “replace” commands that may replace the originating topic's text in the outline with new text. In stage 4, “interview” rules 710 may produce “ask” commands that may insert questions into the outline. In stage 5, “expand” rules 712 may produce “subtopic” commands that may insert subtopics into the outline.

Matching of rules to text may ignore case and tense of verbs, and plurals of nouns, so that “is” in a rule may match “are” in TOPIC. This matching flexibility, and the use of canonicalization rules in stage 1 to convert requests to standardized English, may reduce the total number of rules needed to create a more useful system 200.

FIGS. 7B-F are schematic representations of the five stages of FIG. 7A according to an embodiment of the present invention. In FIG. 7B, in stage 1, rules matching “process ID TOPIC” may translate TOPIC into a standardized (canonical) wording TOPIC2. At this time, all instances of the words “a”, “an”, and “the” may be removed as another form of standardization. Other possible forms of standardization may include spelling correction and converting text to lowercase.

In FIG. 7C, in stage 2, rules matching “scan ID TOPIC” may produce commands of the form “remember ID FACT”. These may cause the inference engine 510 to store new context text strings in the temporary repository 514. After storing a fact internally, the rule may add the command “remember ID FACT” to the list sent back to the browser so that ExecuteCommand 608 may, if desired, add a highlighted caption 710 to the outline topic 504. For example, clicking the “Generate” button on the topic “How does a fish breathe?” may trigger a rule that may respond to the phrase “how does” by storing the context “explain” in memory and by adding the highlighted caption “explain” to the right of the topic.

When a context is stored in the repository 514, the originating topic's ID may be stored with it. Rules may find this context only while processing requests from the originating topic or one of its subtopics. In the example above, if a topic mentions the phrase “how does”, the “explain” context may apply only to that topic and its subtopics.

In FIG. 7D, skipping to stage 5, rules matching the request “expand ID TOPIC” may produce commands of the form “subtopic ID SUBTOPIC”. These may cause ExecuteCommand 608 to insert subtopics 712 into the outline. A new ID may be generated for each new subtopic added.

Stages 3 and 4 may allow the system to ask questions of the user accompanied by input controls such as edit boxes and option buttons to receive the user's answers. In response to an answer from the user, the system may, if desired, modify the outline or mind map and/or send additional requests 516 to the inference engine 510 for processing.

In FIG. 7E, in stage 4, rules matching “interview ID TOPIC” may produce commands of the form “ask ID QUESTION”. Each such command may cause a question 714 and an accompanying edit box 716 to be inserted as a subtopic to topic ID. The edit box may have an onKeyDown handler that, when the user answers the question, may send to the inference engine 510 a new request 516 containing the user's answer embedded within a predefined string. In this way, the user's answer may invoke additional rules that modify the outline or mind map.

For example, an interview rule might insert the question “What country did you visit?” with an edit box to accept the user's answer and put the response string “process ID you visited $answer” into the onKeyDown handler of the edit box. When the user enters text into the edit box and presses the Enter key, the OnKeyDown handler may insert the user's answer in place of the wildcard $answer. When the user enters “China” into the box and presses the enter key, the handler may send the request “process ID you visited China” to the inference engine 510. The new request may modify the outline as shown in the next paragraph about stage 5.

In FIG. 7F, in stage 5, rules matching “update ID TOPIC” may produce commands of the form “replace ID NEW TEXT” that may modify the text of topic ID in the outline. Continuing the example above, a rule matching “update ID you visited China” may send the command “replace ID you visited China” to the browser, thus replacing the question “What country did you visit?”, and the input box, with the text “You visited China”.

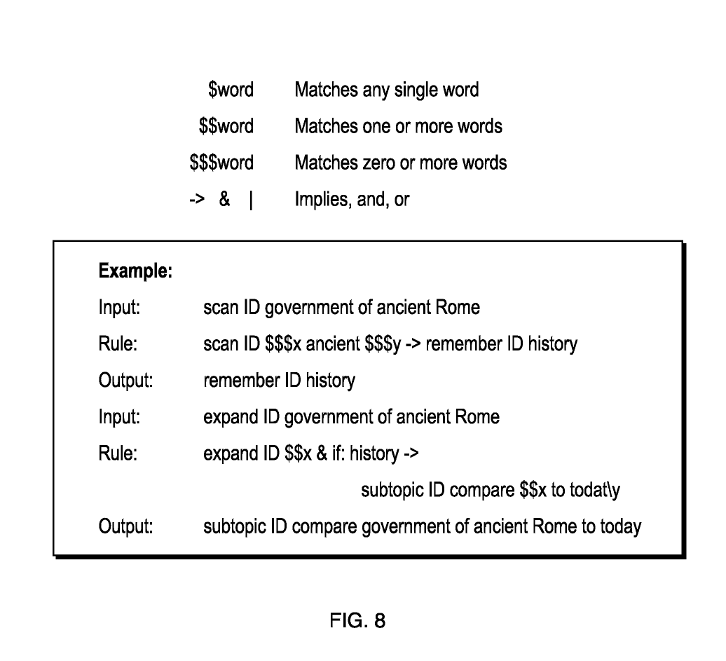

FIG. 8 is a schematic representation of special symbols that may be used to build rules according to an embodiment of the present invention. Words prefixed by the symbols $, $$, and $$$ may be wildcards that match one, one or more, and zero or more words respectively.

An arrow consisting of a dash followed by a greater-than sign may connect the left side of a rule to the right side. The left side of a rule (1) may contain a pattern that may match certain incoming requests and (2) may contain, one or more “if” requirements that may test the existence of context text strings about the outline. The right side of the rule may use the values acquired by wildcards during matching to generate one or more commands.

The example in FIG. 8 shows two rules applied when the user clicks the “Generate subtopics” button on the topic “government of ancient Rome”. The button may send the request “process ID government of ancient Rome” to the inference engine 510. As shown in FIG. 5, rules may translate this request into four internal requests: “scan ID government of ancient Rome”; “update ID government of ancient Rome”; “interview ID government of ancient Rome”; “expand ID government of ancient Rome”. The first of these requests may trigger the rule “scan ID $$$x ancient $$$y→remember ID history” which may cause the context text string “history” to be stored in memory. Subsequently, the fourth request may trigger the rule “expand ID $$x & if: history→subtopic ID compare $$x to today” which may find the “history” context text string that was stored by the previous rule and generate the command “subtopic ID compare government of ancient Rome to today”.

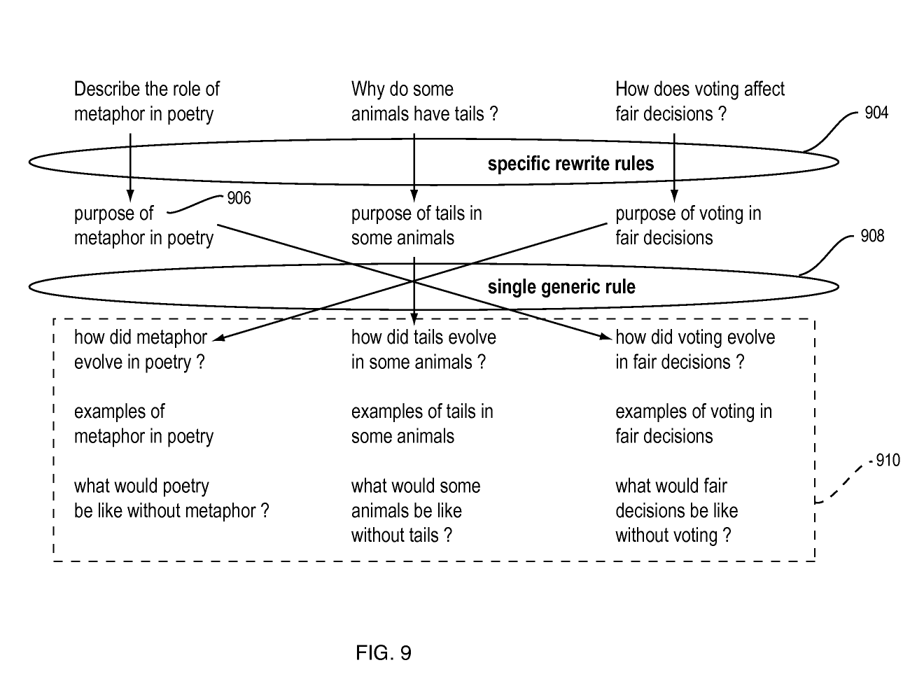

FIG. 9 is a schematic representation illustrating how stage 1 of request processing 904, in which topic text 902 may be translated into a standardized wording 906, may make it possible for a single general rule 908 to produce specific subtopics 910 on a wide range of subjects. Standardization of language (e.g., English) and generality of rules are scaling factors of an embodiment of the present invention, making it possible to build a widely applicable system from a finite number of rules.

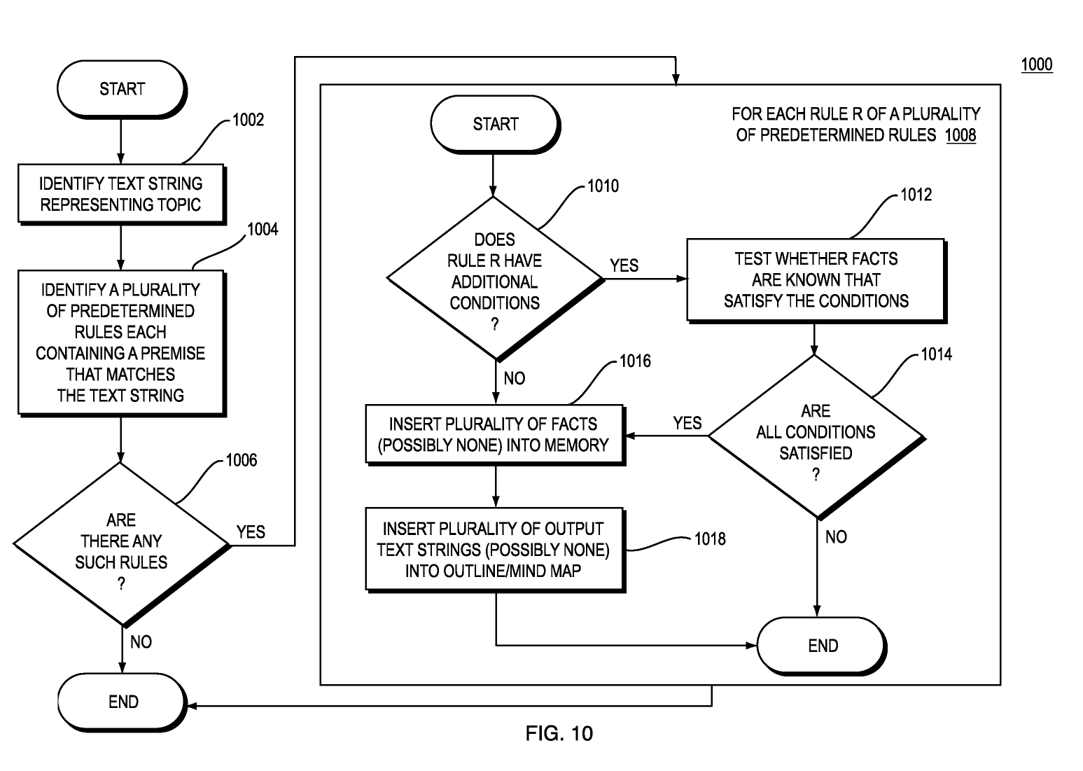

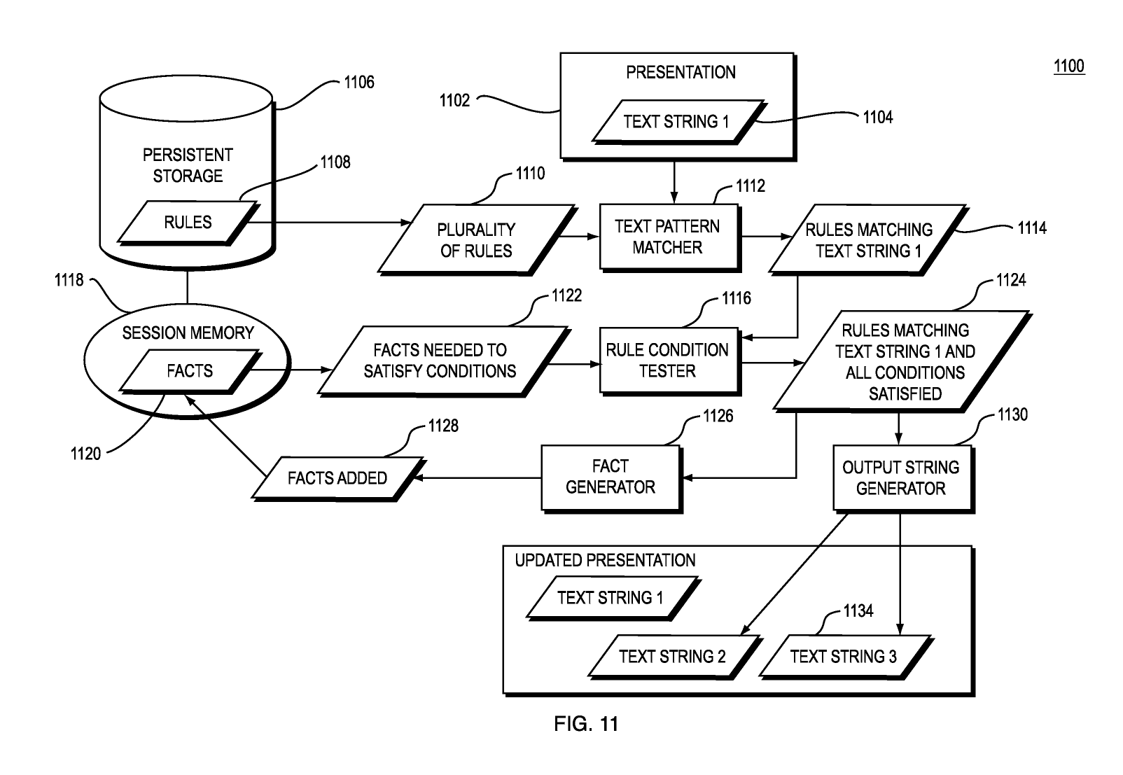

FIG. 10 is a flowchart of a computer-implemented method 1000 according to an embodiment of the present invention. FIG. 11 is a dataflow diagram of a system 1100 to perform the method 1000 of FIG. 10 according to an embodiment of the present invention.

In operation 1002, a text string 1104 may be identified within a presentation 1102. The identification 1002 of the text string 1104 may involve a transformation of a text label into a canonical form, an arbitrary standardized wording that the designers of an embodiment may agree on.

In operation 1004, a determination may be made by a text pattern matcher 1112 whether the input text string 1104 matches any text patterns in the premises of predetermined rules 1110 selected from the total set of rules 1108 residing in persistent storage 1106. The matching process on a text string 1104 may result in the identification of a plurality of rules 1114 each including a pattern that matches the text string 1104. Each rule R may include (1) a premise consisting of a text pattern capable of matching certain text strings; (2) zero or more necessary conditions capable of being satisfied by the existence of specified context text strings in the computer's memory and when satisfied allow the rule to proceed to its conclusions; and (3) a plurality of conclusions, some of which may store more context text strings in memory and some of which may produce output text strings.

In an embodiment that represents a hierarchy, as in an outline or mind map, the context text strings stored by rules applied to a given topic T may be stored in a representation such that they are local to, and findable only within, the portion of the hierarchy underneath T (i.e., findable by rules applied to T and the subtopics of T). For example, a rule may respond to the word “justice” in the text string “Compare Plato's idea of justice to Socrates' idea of justice” by storing the context “law” so that it is known within the subtopics of this text string. In this way, context text strings may define a context or environment local to a given topic with which to explore the subtopics of that topic. In the present example, storing the context “law” locally to the “compare” topic may allow rules specific to law subjects to generate law-related subtopics within this portion of the hierarchy.

Each matching 1006 rule R in the plurality of matching rules 1114 may be sent 1008 to a rule condition tester 1116, which may determine 1010 whether R contains any conditions requiring specific context text strings 1122 to be found within the current plurality of context text strings 1120 within memory 1118. Each such condition of R, if there are any such conditions, may be satisfied by finding the corresponding context text string in memory before the processing of the rule R may continue. Operation 1012 may test whether all such context text strings have been found, meaning that all of rule R's conditions have been satisfied 1014. For each such rule in the plurality of rules 1124 whose conditions have all been satisfied, operation 1016 may apply to rule R a fact generator 1126, which may store a plurality of context text strings 1128 in memory so that they may potentially by used to satisfy the conditions of rules processed in the future. Operation 1018 may also apply to rule R an output string generator 1130, which may identify a plurality of output text strings 1134 generated from the values that were assigned to wildcard terms by the text pattern matcher 1112 and from other text contained within the conclusions of rule R. This plurality of output text strings 1134 may be added to the presentation as subtopics of the input text string 1104 to produce an updated presentation 1132 to the user.

Rule Language

The inference rules 512 and the inference engine 510 that may power an embodiment of the present invention's brainstorming capability may be components similar to those commonly found in expert systems, online chat-bots, dynamic content generators, and other computer applications that may use available facts or data to produce conclusions and may control the behavior of software.

The chosen rule language was developed by the inventor, and will be referred to in this document as the “preferred rule language.” The preferred rule language is not, however, the only choice available for embodiments of the present invention. The preferred rule language was designed with natural language text in mind, uses a rich and flexible text pattern syntax, and allows unlimited forward and backward chaining and nesting of deductions. The specific rule language features that may be required are listed at the end of this section along with examples of how these features may be implemented in other rule languages.

The preferred rule language combines features from widely available expert system shells, Artificial Intelligence languages, chat bot scripting languages, production rule systems, rewrite grammars, decision support languages, and business rule software. The following list describes several of the most popular of these software products in current use:
1. Prolog: Created in 1972, Prolog has been in continuous use ever since to build expert systems and other software applications that involve reasoning. Commercial versions of Prolog include GNU Prolog, Bprolog, and Turbo Prolog (discontinued). Prolog applies pattern rules to text sentences in a backward-chaining fashion to prove logical conclusions by searching a set of facts.
2. HaleyRules/CLIPS: Created as CLIPS by NASA in 1983, renamed Eclipse and then Haley Eclipse, HaleyRules is a rule language with nested LISP-like syntax and wildcard variables similar to Prolog. HaleyRules is in widespread commercial use. CLIPS as a public domain project is free of charge.
3. Java Expert System Shell (Jess): Created in 1995 at Sandia National Laboratories, Jess is a widely used expert system language for the Java platform with many of the features needed to implement embodiments of the present invention. Its rules use patterns to build text from text and can be executed both forward and backward. It is available free of charge for academic research and by license fee for commercial applications.
4. Artificial Intelligence Markup Language (AIML): Created between 1995 and 2000, this language is designed for the creation of chat bots, computer programs that simulate humans in chat sessions. AIML is the foundation of A.L.I.C.E. (Artificial Linguistic Internet Computer Entity), which won the 2000 Loebner Prize as the simulation software most often mistaken for a human respondent.
5. ILOG Rules: A product of ILOG Corporation, this is an object-oriented general purpose inference language, rule engine, and visual programming environment. Objects and their properties are first defined, then business rules are written that test conditions on the object properties. ILOG Rules is in widespread commercial use. Since ILOG Rules is object-based rather than text-based, using ILOG Rules for an embodiment of the present invention may require creating definitions of object types and their semantic relationships for all of the words and phrases represented by the embodiment.
6. Semantics of Business Vocabulary and Rules (SBVR): Created by the Object Management Group and currently used for commercial applications, this is another object-based rule language requiring the same additional effort as ILOG Rules for an embodiment of the present invention.

The above list presents examples only and is not meant to be exhaustive.

The requirements of a rule language (syntax) and inference engine (software) to support an embodiment of the present invention may include:
1. Accept a set of strings in and apply rules to them to produce a set of strings out. The strings coming in are requests from the user interface in response to user actions, such as clicking a button to expand a topic, or answering a question. The strings going out are commands that cause the user interface to do something, such as add a topic or ask a question.
2. Transform strings by applying rules that can arbitrarily rewrite their text. This is done by matching text patterns to the input strings, assigning values to the wildcard variables in the patterns, and using the values of these variables to construct output strings. This provides sufficient flexibility so that rules can perform the transformations described.
3. Control the order in which rules are applied so that rules with more specific text patterns (those with more non-variable words) can be tried before those with more general patterns. This special-casing capability may be needed to process natural language sentences.
4. During the application of rules, store facts in memory about the user session and retrieve these facts to modify the results of applying later rules.

Each of these requirements is addressed by features listed below. Each feature's description includes an example of the feature as embodied in the preferred rule language and one or more examples of the same feature as embodied in other rule-based software products.

Several additional useful features of the preferred rule language are shared by all of these products and by rule languages in general. These are: an Application Programming Interface (API) for communicating with other software (such as the ISAPI DLL 610 included in the embodiment shown), support for a knowledgebase containing thousands of rules, the ability to combine multiple individual modules of rules, and debugging aids for testing that rules fire correctly.

Feature: Forward rule execution: An input string triggers a rule, which tests additional rule conditions as necessary and then produces an output string.

### Examples:

Preferred Rule Language:
RULE: bye & logged in→see you later
INPUT: bye
FOUND: logged in
OUTPUT: see you later

Jess:

```
(defrule water-faucet
    (logical (faucet-open)) =>
    (assert (water-flowing)))
```

ILOG Rules:

```
rule YoungBorrower {
    when {
        ?l: LoanApplication(loanAmount >
                100000);
        ?b: Borrower(age( ) < 25) from
                ?l.applicant);
        } then {
        execute ?loanApp.GenerateMessage(
            “Speak with loan officer”);
        }}
```

CLIPS:

```
(deftemplate Company (field name))
  (deftemplate Person (field name)
            (field employer))
  (deftemplate Vehicle (field vin)
            (field owner))
  (defrelation vehicle-to-be-towed (?))
  (defrule nominate-vehicle-to-be-towed
    (Company (name ?company))
    (join (Vehicle (owner ?person) (vin ?vehicle))
    (not (Person (name ?person)
            (employer ?company)))) =>
    (infer (vehicle-to-be-towed ?vehicle)))
```

Feature: Backward rule execution: When the inference engine 510 needs to satisfy a rule condition, it can verify the condition by triggering a second rule whose conclusion matches the condition.

### Examples:

Preferred Rule Language:
RULE: age>15→eligible to drive
ADD: age>15
FIND: eligible to drive
FIND: age>15
FOUND: age>15
FOUND: eligible to drive

Prolog:

```
wet :- raining.
    raining.
    ?- wet.
    Yes
```

SBVR:
For each Invoice, if that Invoice was issued on Date1 then it is obligatory that that Invoice is paid on Date2 where Date2<=Date1+30 days.

Feature: Chained rule execution: The output of each rule becomes an input to any matching rules until no further rules can be applied. Rules can be chained both forward and backward.

### Examples:

Preferred Rule Language:
RULE: age>15→eligible to drive
ADD: age>15
RULE: want license & eligible to drive→get license
INPUT: want license
FIND: eligible to drive
FIND: age>15
FOUND: age>15
FOUND: eligible to drive
OUTPUT: get license

Prolog:

```
animal_is(zebra) :-
    animal_is(ungulate),
    positive(has, black_stripes).
animal_is(ungulate) :-
    animal_is(mammal),
    positive(has,hooves).
```

Feature: Pattern matching: A flexible pattern language can be used to respond to arbitrary sentence structures.

### Examples:

Preferred Rule Language:
$word—exactly one word
   $$word—one or more words
   $$$word—zero or more words
PATTERN: $$x because $$y
MATCHES: England won because it had a stronger navy
DOESN'T MATCH: because I said so
DOESN'T MATCH: just because

Prolog:
X, Person

Jess, CLIPS:
?x, ?person

AIML:
asterisk, underscore

Feature: Variables bound per rule: Matching a pattern in a rule assigns words and phrases to wildcard variables for the duration of the rule, thus allowing the rule to use the same variable values to generate customized output.

### Examples:

Preferred Rule Language:
RULE: my name is $$name→nice to meet you, $$name
INPUT: my name is Ida Claire
OUTPUT: nice to meet you, Ida Claire

Prolog:

```
cat(X) :- cougar(X).
    cougar(tom).
    ?- cat(tom).
    Yes
```

Jess:

(defrule cars-are-vehicles
(car ?x) => (vehicle ?x))

AIML:
<that>, <thatstar>

Feature: Deterministic rule order: Rules can be made to fire in a specific order. It is therefore possible to ensure that more specific rules are applied before (or instead of) more general rules. This feature supports a hierarchy of special cases in text matching, to handle the grammar of longer, more complicated sentences using different rules from the grammar of shorter sentences. In the preferred rule language, rule order is related to the order that the rules appear in the source files. More specifically, for each non-wildcard word being searched, rules containing that word within a given module are found in the order that the rules appear in the source file for that module. Other rule languages use various methods of “conflict resolution” such as assigning priorities to rules or choosing the most specific rule first.

### Examples:

Preferred Rule Language:
RULE: $$x believe $$y causes $$z→Why do you think $$y causes $$z? & .stop
RULE: $$x causes $$z→Why do you think $$y causes $$z?
INPUT: warm air rising causes hurricanes
OUTPUT: Why do you think warm air rising causes hurricanes?
INPUT: scientists believe warm air rising causes hurricanes
OUTPUT: Why do you think warm air rising causes hurricanes?

CLIPS supports several ways of choosing the next rule from its Agenda, including most recent first, most specific first, random, or as added (shown):

```
CLIPS> (defrule r1
            (loves jane tarzan)
            (loves tarzan jane)
        =>
            (assert (happy tarzan))
            (assert (happy jane)))
CLIPS> (defrule r2
            (loves ?x ?y)
        =>
            (assert (lovable ?y)))
CLIPS> (assert (loves jane tarzan))
<Fact-1>
CLIPS> (agenda)
0 r1: f-1,f-0
0 r2: f-1
0 r2: f-0
```

For a total of 3 activations.

Feature: Nested deductions: Any rule output can contain a portion that is replaced by the result of applying rules to a separate sentence.

### Examples:

Preferred Rule Language:
RULE: tell me $$x→ok, [reverse $$x]
RULE: tell me $$$a I $$$b→$$$a you $$$b
INPUT: tell me I have to go
OUTPUT: ok, you have to go

AIML:
Input normalization

Feature: Fact repository: Rules can store sentences in a temporary memory so that other rules can refer to them.

### Examples:

Preferred Rule Language:
RULE: remember $$x→.ma the_case $$x
INPUT: remember personal narrative (adds “personal narrative” to module “the_case”)
RULE: .mf $$x→if: $$x
RULE: $$$x your $$$y & if: personal narrative→using second person in a personal narrative
INPUT: we went to your favorite restaurant
FIND: if: personal narrative
FIND (the_case): personal narrative
FOUND (the_case): personal narrative
FOUND: if: personal narrative
OUTPUT: using second person in a personal narrative

Prolog:

```
personal narrative :- true.
        using 2nd person in a narrative :-
        X you Y,
        Personal narrative.
```

Inference Engine Implementation

An embodiment of the inference engine 510 used in the described embodiment to execute the preferred rule language was created by the inventor using Microsoft Visual C++ 6.0 and is referred to as the “preferred inference engine”. The preferred inference engine 510 may be used for implementing the preferred rule language due to its efficient search and its support for all of the rule language features needed for an embodiment of the invention. Note, however, that inference engines other than the preferred inference engine 510 may be used in embodiments of the present invention.

The preferred inference engine 510 is described only briefly because (1) many widely available software products such as the ones described above have their own inference engines, and (2) a person skilled in the art of computer programming can build an inference engine without much difficulty. There are many ways to accomplish rule storage, search, matching, and chained forward and backward deduction. Inputs and outputs can be represented as, for example, character strings, objects, linked networks, or rows in a relational database. Choices regarding programming language, communication protocol, and method of persistent storage will depend on the platform and the user application for the embodiment of the invention.

The preferred inference engine 510 is a Windows executable program that communicates with an ISAPI DLL 610 via a named pipe. Each request string 516 that the ISAPI DLL receives from a browser is passed to the inference engine 510. The inference engine 510 divides the string into a set of sentences, compiles each sentence into an efficient internal format, then applies rules to each compiled sentence. The final results of rule application are converted back to strings and returned as a string of commands 518 via the ISAPI DLL to the browser, where they are executed by JavaScript functions 606.

The preferred inference engine's knowledgebase consists of one or more named modules containing rules and sentences. The source code of each module is a named file on the server computer. The compiled version of the module resides in memory. The inference engine 510 can be instructed to search an arbitrary set of compiled modules in a specified order so that matching will find rules or sentences in any of those modules. Compiled versions of sentences and rules are highly optimized for fast searching and matching.

The chosen embodiment designates one module per user session, named “the_case”, to contain all of the session-specific sentence facts generated by and later tested by rules. The contents of this module persist for the duration of the user session.

Matching of compiled rules to compiled sentences is facilitated by an index that quickly locates all occurrences of a given word. To process a compiled input sentence, the preferred inference engine 510 does the following:
1. For each non-wildcard word in the sentence, it searches the index in each shared module for occurrences of that word in the left (input) sides of rules.
2. For each rule whose left side contains the word, it attempts a match.
3. Matching proceeds outward in both directions from the specified word. Each non-wildcard word in the rule must be identical to the corresponding word in the sentence. When a wildcard is encountered in the rule, the next non-wildcard word in the rule pattern, or the end of the rule pattern, determines the sequence of words in the sentence that must be assigned as the value of the wildcard.
4. If the match succeeds, the engine replaces wildcards with their assigned values in all of the other patterns on the left side of the rule. The resulting sentences must be found in the knowledgebase, or matched to existing sentences if they still contain unassigned wildcards, or deduced by backward application of other rules.
5. If all of the patterns on the left side of the rule have been thus instantiated, the patterns on the right (output) side of the rule have their wildcards replaced by the assigned values to produce one or more output sentences.
6. Output sentences in turn are candidates to be input into other rules (forward chaining). Each application of a rule has its own independent set of wildcard/value assignments.
7. The output sentences to which no further rules can be applied are returned to the ISAPI DLL as the set of final outputs for the original input sentence.

The inference engine 510 is a simple, replaceable, general purpose component. An embodiment of the present invention may derive capabilities from the structure of the input request sentences (such as those beginning with “scan”, “update”, “interview”, and “expand”), the rules that are applied to these sentences as described, and the actions taken by user interface (e.g., browser) scripts in response to the output command sentences by modifying the outline, asking questions, and displaying information to the user.

It is to be understood that although the invention has been described above in terms of particular embodiments, the foregoing embodiments are provided as illustrative only, and do not limit or define the scope of the invention. Various other embodiments, including but not limited to the following, are also within the scope of the claims.

Although certain examples described herein involve the automatic identification of “subtopics” of a given topic, embodiments of the present invention are not limited to identifying subtopics of a given topic. Rather, when a user selects a topic label describing a topic, the techniques disclosed herein may be applied to generate or otherwise identify text that describes not only subtopics of the selected topic, but also any kind of text that is related to the selected topic, such as topics related to the selected topic but which are not subtopics of the selected topic, questions about the selected topic, and statements providing further details about the selected topic. These are merely examples of the kinds of text that may be identified using embodiments of the present invention, and do not constitute limitations of the present invention.

Elements and components described herein may be further divided into additional components or joined together to form fewer components for performing the same functions.

The techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

What is claimed is:

1. A computer-implemented method comprising:
(A) identifying an input text string representing a topic;
(B) determining whether the input text string matches a text pattern specified by a premise of a predetermined rule;
(C) if the input text string satisfies the text pattern, then identifying a plurality of output text strings specified by a conclusion of the predetermined rule.

2. The method of claim 1, further comprising:
(D) before (B), identifying a canonical text string by applying, to the input text string, a canonical transformation rule which maps a plurality of forms of sentences into a single canonical form.

3. The method of claim 1, wherein (C) comprises identifying a plurality of output text strings including at least some text from the input text string.

4. The method of claim 1, wherein (B) comprises, for each rule R of a plurality of predetermined rules:
(B1) identifying a text pattern specified by a premise of rule R;
(B2) determining whether the input text string matches the text pattern specified by the premise of rule R; and wherein (C) comprises:
(C1) if the input text string satisfies the text pattern specified by the premise of rule R, then identifying a plurality of output text strings specified by a conclusion of rule R.

5. The method of claim 1, wherein (A) comprises:
(A1) identifying an input text string representing a topic; and wherein (B) comprises:
(B1) determining whether the input text string matches a text pattern specified by a premise of a predetermined rule, the text pattern including at least one wildcard term, by examining a portion of the text pattern not including the at least one wildcard term.

6. The method of claim 1, wherein (A) comprises:
(A1) identifying an input English text string representing a topic.

7. The method of claim 1, wherein (B) comprises:
(B1) determining whether the input text string matches a text pattern specified by a premise of a predetermined specific rule.

8. The method of claim 1, wherein (B) comprises:
(B1) determining whether the input text string matches a text pattern specified by a premise of a predetermined general rule.

9. The method of claim 1, further comprising:
(D) outputting the plurality of output text strings.

10. The method of claim 9, wherein the outputted plurality of output strings are editable as part of an outline or mind map.

11. The method of claim 1, wherein (B) further comprises:
(B1) in addition to determining whether the input text string matches the text pattern specified by the premise of the predetermined rule, generating a context text string based on the input text string and storing the context text string in memory.

12. The method of claim 5, wherein (B1) comprises:
(B1A) identifying the at least one wildcard term by comparing non-wildcard portions of the text string and the text pattern and assigning an intervening portion of the text string to the at least one wildcard term.

13. The method of claim 12, wherein (B1) comprises:
(B1A) examining the at least one wildcard term in addition to the portion of the text pattern not including the at least one wildcard term in the determining whether the input text string matches the text pattern specified by the premise of the predetermined rule.

14. A computer-implemented method comprising:
(A) selecting, on a computerized display, an input text string representing a topic;
(B) identifying a canonical text string by applying, to the input text string, a canonical transformation rule which maps a plurality of forms of sentences into a single canonical form;
(C) for each rule R of a plurality of predetermined rules:
(C1) identifying a text pattern specified by a premise of rule R;
(C2) determining whether the identified canonical text string matches the text pattern specified by the premise of rule R;
(D) if the identified canonical text string satisfies the text pattern specified by the premise of rule R, then identifying a plurality of output text strings specified by a conclusion of rule R;
(E) outputting the plurality of output text strings on the computerized display.

15. The method of claim 14, wherein (D) comprises identifying a plurality of output text strings including at least some text from the input text string.

16. The method of claim 14, wherein the outputted plurality of output strings are editable as part of an outline or mind map.

17. The method of claim 14, wherein (A) comprises selecting, by at least one of typing, editing, and inserting, on a computerized display, an input text string representing a topic.

18. The method of claim 14, wherein (C2) further comprises:
(C2A) in addition to determining whether the canonical text string matches the text pattern specified by the premise of the rule R, determining if there exists at least one specific context text string in memory, and wherein (D) further comprises:
(D1) in addition to if the canonical text string satisfies the text pattern, if there exists the at least one specific context text string in memory, then identifying the plurality of output text strings specified by the conclusion of the rule R.

19. The method of claim 11, wherein (B) further comprises:
(B2) using the context text string stored in memory in determining whether the input text string matches the text pattern specified by the premise of the predetermined rule.

20. An apparatus comprising
means for identifying an input text string representing a topic;
means for determining whether the input text string matches a text pattern specified by a premise of a predetermined rule; and
means for identifying a plurality of output text strings specified by a conclusion of the predetermined rule if the input text string satisfies the text pattern, then.

21. An apparatus comprising:
means for selecting, on a computerized display, an input text string representing a topic;
means for identifying a canonical text string by applying, to the input text string, a canonical transformation rule which maps a plurality of forms of sentences into a single canonical form;
for each rule R of a plurality of predetermined rules:
means for identifying a text pattern specified by a premise of rule R;
means for determining whether the identified canonical text string matches the text pattern specified by the premise of rule R;
means for identifying a plurality of output text strings specified by a conclusion of rule R if the identified canonical text string satisfies the text pattern specified by the premise of rule R; and
means for outputting the plurality of output text strings on the computerized display.
